(19) United States
(12) Patent Application Publication
(10) Pub. No.: US 2024/0385617 A1
(43) Pub. Date: Nov. 21, 2024

(54) AUTONOMOUS DRIVING CONTROL APPARATUS AND METHOD THEREFOR

(71) Applicants: HYUNDAI MOTOR COMPANY, Seoul (KR); KIA CORPORATION, Seoul (KR)

(72) Inventors: Seung Yong Lee, Uiwang-si (KR); Yun Sub Kim, Suwon-si (KR); Ga Hee Kim, Seoul (KR); Hwan Hee Lee, Gunpo-si (KR)

(73) Assignees: HYUNDAI MOTOR COMPANY, Seoul (KR); KIA CORPORATION, Seoul (KR)

(21) Appl. No.: 18/383,337

(22) Filed: Oct. 24, 2023

(30) Foreign Application Priority Data
May 15, 2023 (KR) 10-2023-0062639

(51) Int. Cl. G05D 1/02; G06T 7/70

(52) U.S. Cl. CPC G05D 1/0212; G06T 7/70; G06T 2207/10028

(57) ABSTRACT

An autonomous driving control apparatus includes a sensor device, a memory storing instructions, and a controller. The autonomous driving control apparatus obtains first sensing data about a driving path of a driving device using a first sensor, identifies a first specified object included in the first sensing data and meeting a specified condition, identifies a first sampling rate to be applied to a first point cloud data corresponding to the first specified object, obtains second sensing data about the driving path using a second sensor, identifies a second specified object included in the second sensing data, identifies a second sampling rate to be applied to second point cloud data corresponding to the second specified object, and samples the first sensing data and the second sensing data respectively using the first sampling rate and the second sampling rate.

### CROSS-REFERENCE TO RELATED APPLICATION

This application claims the benefit of priority to Korean Patent Application No. 10-2023-0062639, filed in the Korean Intellectual Property Office on May 15, 2023, the entire contents of which are incorporated herein by reference.

### TECHNICAL FIELD

The present disclosure relates to an autonomous driving control apparatus and a method therefor, and more particularly, relates to technologies for obtaining various pieces of data for driving of a driving device (e.g., a mobile robot).

### BACKGROUND

With the development of technology, various technologies for driving devices have been developed. For example, as more pieces of data are used to control the driving of a driving device to a destination, various methods for processing the data have been developed.

The driving device may be implemented as various types of autonomous vehicles, mobile robots, and aerial vehicles, all of which may all be unmanned, for example.

Particularly, a mobile robot may be used for various

purposes in various environments. For example, the mobile robot may move based on autonomous driving technology in a specified building (e.g., a hotel, a restaurant, or the like). For example, the mobile robot may identify pieces of information about a current location or a surrounding situation in real-time using at least one sensor included in the mobile robot. The mobile robot may then perform autonomous driving based on at least some of the identified pieces of information.

However, when performing autonomous driving for the mobile robot, because a large amount of data should be calculated to identify location information, or required data (e.g., map data) should be stored for driving, it may be difficult to perform a normal operation because a load occurs, or because a storage capacity is insufficient in the processing.

### SUMMARY

The present disclosure has been made to solve the above-mentioned problems occurring in the prior art while advantages achieved by the prior art are maintained intact.

An aspect present disclosure provides an autonomous driving control apparatus for identifying different sampling rates depending on whether a specified object is identified for pieces of sensing data obtained using different types of sensors (e.g., a camera and light detection and ranging (LiDAR)), and a method therefor.

Another aspect of the present disclosure provides an autonomous driving control apparatus for identifying a sampling rate to be applied to point cloud data (PCD) corresponding to an identified object based on a predefined condition and sampling sensing data, when the object meeting a specified condition is identified from data (e.g., point cloud data) obtained using a sensor, and a method therefor.

Another aspect of the present disclosure provides an autonomous driving control apparatus for generating voxel data including location information of a specified object, based on at least a portion of sampled sensing data, and storing map data including the voxel data in a memory, and a method therefor.

Another aspect of the present disclosure provides an autonomous driving control apparatus for differently setting a weight for a portion that does not meet a specified condition (or a portion that does not include a specified object) and a weight for a portion meeting the specified condition (or a portion including the specified object) and comparing pieces of voxel data based on the set weights, and a method therefor.

The technical problems to be solved by the present disclosure are not limited to the aforementioned problems, and any other technical problems not mentioned herein should be clearly understood from the following description by those having ordinary skill in the art to which the present disclosure pertains.

According to an aspect of the present disclosure, an autonomous driving control apparatus may include: a sensor device including at least one sensor; a memory storing at least one instruction; and a controller electrically connected with the sensor device and the memory. The at least one instruction may be configured to, when executed by the controller, cause the autonomous driving control apparatus to: obtain first sensing data about a driving path of a driving device, using a first sensor among the at least one sensor; identify a first specified object included in the first sensing data and meeting a specified condition, and identify a first sampling rate to be applied to a first point cloud data corresponding to the first specified object; obtain second sensing data about the driving path, using a second sensor among the at least one sensor; identify a second specified object included in the second sensing data and identify a second sampling rate to be applied to second corresponding to the second specified object based on a result of comparing the first specified object with the second specified object; and sample the first sensing data and the second sensing data respectively using the first sampling rate and the second sampling rate.

According to an embodiment, the at least one instruction may be configured to, when executed by the controller, cause the autonomous driving control apparatus to: sample the first point cloud data corresponding to the first specified object in the first sensing data, using the first sampling rate; and sample the second point cloud data corresponding to the second specified object in the second sensing data, using the second sampling rate.

According to an embodiment, the at least one instruction may be configured to, when executed by the controller, cause the autonomous driving control apparatus to identify the second sampling rate as the same value as the first sampling rate or a value greater than the first sampling rate, when it is identified that the first specified object and the second specified object are the same as each other.

According to an embodiment, the at least one instruction may be configured to, when executed by the controller, cause the autonomous driving control apparatus to sample at least a portion of the second sensing data using a predefined sampling rate, when the first specified object and the second specified object are not the same as each other or when the second specified object is not included in the second sensing data.

According to an embodiment, the predefined sampling rate may be less than the first sampling rate.

According to an embodiment, the at least one instruction may be configured to, when executed by the controller, cause the autonomous driving control apparatus to generate first voxel data including location information of at least one of the first specified object, the second specified object, or a combination thereof, based on at least one of the sampled first sensing data, the sampled second sensing data, or a combination thereof. The at least one instruction may also be configured to, when executed by the controller, store map data including the first voxel data in the memory.

According to an embodiment, the at least one instruction may be configured to, when executed by the controller, cause the autonomous driving control apparatus to generate second voxel data based on third sensing data obtained using the second sensor and identify a current location of the driving device, based on a result of matching the first voxel data included in the map data with the second voxel data.

According to an embodiment, the at least one instruction may be configured to, when executed by the controller, cause the autonomous driving control apparatus to set a weight for a portion that does not meet the specified condition between the first voxel data and the second voxel data to a first value and match the first voxel data with the second voxel data. The at least one instruction may also be configured to, when executed by the controller, set a weight for a portion meeting the specified condition to a second value greater than the first value and match the first voxel data with the second voxel data. The portion may include at least one of the first specified object, the second specified object, or a combination thereof.

According to an embodiment, the second voxel data may include voxel coordinates of a blob corresponding to at least one object meeting the specified condition.

According to an embodiment, the at least one instruction may be configured to, when executed by the controller, cause the autonomous driving control apparatus to apply a point cloud registration algorithm to the first voxel data and the second voxel data to generate the result.

According to another aspect of the present disclosure, an autonomous driving control method may include: obtaining, by a controller, first sensing data about a driving path of a driving device using a first sensor; identifying, by the controller, a first specified object included in the first sensing data and meeting a specified condition, and identifying, by the controller, a first sampling rate to be applied to a first point cloud data corresponding to the first specified object; obtaining, by the controller, second sensing data about the driving path using a second sensor; identifying, by the controller, a second specified object included in the second sensing data and identifying, by the controller, a second sampling rate to be applied to second point cloud data corresponding to the second specified object based on a result of comparing the first specified object with the second specified object; and sampling, by the controller, the first sensing data and the second sensing data respectively using the first sampling rate and the second sampling rate.

According to an embodiment, sampling the first sensing data and the second sensing data respectively using the first sampling rate and the second sampling rate by the controller may include sampling, by the controller, the first point cloud data corresponding to the first specified object in the first sensing data using the first sampling rate and sampling, by the controller, the second point cloud data corresponding to the second specified object in the second sensing data using the second sampling rate.

According to an embodiment, identifying the second sampling rate by the controller may include identifying, by the controller, the second sampling rate as the same value as the first sampling rate or a value greater than the first sampling rate when it is identified that the first specified object and the second specified object are the same as each other.

According to an embodiment, sampling the first sensing data and the second sensing data respectively using the first sampling rate and the second sampling rate by the controller may include sampling, by the controller, at least a portion of the second sensing data using a predefined sampling rate when the first specified object and the second specified object are not the same as each other or when the second specified object is not included in the second sensing data.

According to an embodiment, the predefined sampling rate may be less than the first sampling rate.

According to an embodiment, the autonomous driving control method may further include generating, by the controller, first voxel data including location information of at least one of the first specified object, the second specified object, or a combination thereof, based on at least one of the sampled first sensing data, the sampled second sensing data, or a combination thereof. The autonomous driving control method may further include storing, by the controller, map data including the first voxel data in a memory.

According to an embodiment, the autonomous driving control method may further include generating, by the controller, second voxel data based on third sensing data obtained using the second sensor and identifying, by the controller, a current location of the driving device, based on a result of matching the first voxel data included in the map data with the second voxel data.

According to an embodiment, identifying the current location of the driving device, based on the result of matching the first voxel data included in the map data with the second voxel data, by the controller, may include setting, by the controller, a weight for a portion which does not meet the specified condition between the first voxel data and the second voxel data to a first value and matching, by the controller, the first voxel data with the second voxel data. Identifying the current location of the driving device may further include setting a weight for a portion meeting the specified condition, the portion including at least one of the first specified object, the second specified object, or a combination thereof, to a second value greater than the first value and matching, by the controller, the first voxel data with the second voxel data.

According to an embodiment, the second voxel data may include voxel coordinates of a blob corresponding to at least one object meeting the specified condition.

According to an embodiment, identifying the current location of the driving device, based on the result of matching the first voxel data included in the map data with the second voxel data, by the controller, may include applying, by the controller, a point cloud registration algorithm to the first voxel data and the second voxel data to generate the result.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating components of an autonomous driving control apparatus according to an embodiment of the present disclosure;

FIG. 2 is an operational conceptual diagram of an autonomous driving control apparatus according to an embodiment of the present disclosure;

FIG. 3 is an operational conceptual diagram of an autonomous driving control apparatus according to an embodiment of the present disclosure;

FIG. 4 is an operational flowchart of an autonomous driving control method according to an embodiment of the present disclosure;

FIG. 5 is an operational flowchart of an autonomous driving control method according to an embodiment of the present disclosure;

FIG. 6 is an operational flowchart of an autonomous driving control method according to an embodiment of the present disclosure; and

FIG. 7 illustrates a computing system of an autonomous driving control apparatus according to an embodiment of the present disclosure.

Regarding the description of the drawings, the same or similar denotations may be used for the same or similar components.

### DETAILED DESCRIPTION

Hereinafter, some embodiments of the present disclosure are described in detail with reference to the drawings. In the drawings, the same reference numerals are used throughout to designate the same or equivalent elements. In addition, detailed description of well-known features or functions have been omitted in order not to unnecessarily obscure the gist of the present disclosure.

In describing the components of embodiments according to the present disclosure, terms such as first, second, “A”, “B”, (a), (b), and the like may be used. These terms are only used to distinguish one element from another element, but do not limit the corresponding elements irrespective of the order or priority of the corresponding elements. Furthermore, unless otherwise defined, all terms including technical and scientific terms used herein are to be interpreted as is customary in the art to which this disclosure belongs. It should be understood that terms used herein should be interpreted as having a meaning that is consistent with their meaning in the context of this disclosure and the relevant art and should not be interpreted in an idealized or overly formal sense unless expressly so defined herein.

When a component, device, element, or the like, of the present disclosure, is described as having a purpose or performing an operation, function, or the like, the component, device, or element should be considered herein as being “configured to” meet that purpose or to perform that operation or function.

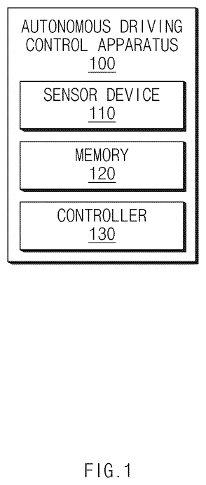

Hereinafter, embodiments of the present disclosure are described in detail with reference to FIGS. 1-7.

FIG. 1 is a block diagram illustrating components of an autonomous driving control apparatus according to an embodiment of the present disclosure.

According to an embodiment, an autonomous driving control apparatus 100 may include at least one of a sensor device 110, a memory 120, a controller 130, or a combination thereof. The components of the autonomous driving control apparatus 100, which are shown in FIG. 1, are illustrative, and embodiments of the present disclosure are not limited thereto. For example, the autonomous driving control apparatus 100 may further include components (e.g., an interface, a display, a sound output device, a communication device) that are not shown in FIG. 1.

According to an embodiment, the autonomous driving control apparatus 100 may control a driving device (e.g., a mobile using at least some of the above-mentioned components.

According to an embodiment, the sensor device 110 may obtain (or sense) various pieces of information used for driving a mobility device. As used throughout this disclosure, the phrase “mobility device” is intended to mean any moving vehicle, device, machine, instrument, apparatus, or the like.

For example, the sensor device 110 may include at least one sensor including at least one of a camera, radar, light detection and ranging (LiDAR), or a combination thereof.

For example, the sensor device 110 may obtain information about an external object (e.g., at least one of a person, another vehicle, a building, a structure, or a combination thereof), using the at least one sensor.

As an example, the sensor device 110 may include a first sensor including various types of cameras. For example, the first sensor may include a red-green-blue (RGB) camera. The sensor device 110 may obtain first sensing data including an RGB image, using the RGB camera. The first sensing data may include, for example, image data about a driving path of the driving device.

As an example, the sensor device 110 may include a second sensor including various types of LiDAR. For example, the second sensor may include three-dimensional (3D) LiDAR. The sensor device 110 may obtain second sensing data using the 3D LIDAR. The second sensing data may include, for example, LiDAR data about a driving path of the driving device.

According to an embodiment, the memory 120 may store a command or data. For example, the memory 120 may store one or more instructions, when executed by the controller 130, causing the autonomous driving control apparatus 100 to perform various operations.

For example, the memory 120 and the controller 130 may be implemented as one chipset. The controller 130 may include at least one of a communication processor, a modem, or other such component or device.

For example, the memory 120 may store various pieces of information associated with the autonomous driving control apparatus 100. As an example, the memory 120 may store information about an operation history of the controller 130. As an example, the memory 120 may store pieces of information associated with states and/or operations of components (e.g., a driving device (or a motor)) of the mobility device (or the mobile robot) controlled by the autonomous driving control apparatus 100 and/or components (e.g., at least one of the sensor device 110, the controller 130, or a combination thereof) of the autonomous driving control apparatus 100.

According to an embodiment, the controller 130 may be operatively connected with at least one of the sensor device 110, the memory 120, or a combination thereof. For example, the controller 130 may control an operation of at least one of the sensor device 110, the memory 120, or a combination thereof.

For example, the controller 130 may control autonomous driving of the driving device. The controller 130 may obtain various pieces of sensing data about a driving path of the driving device using the sensor device 110.

As an example, the controller 130 may obtain first sensing data about a driving path of the driving device using the first sensor (e.g., the RGB camera) included in the sensor device 110.

As an example, the controller 130 may obtain second sensing data about a driving path of the driving device using the second sensor (e.g., the 3D LiDAR) included in the sensor device 110.

For example, the controller 130 may identify objects included in the sensing data and may determine whether there is a specified object meeting a specified condition among the identified objects.

As an example, the controller 130 may identify a first specified object that is included in the first sensing data and meets the specified condition and may identify a first sampling rate to be applied to first point cloud data corresponding to the first specified object among the first sensing data.

As an example, the specified condition may include a condition associated with at least one of a size of an object, a shape of the object, a color of the object, a volume of the object, a weight of the object, an appearance of the object, or a combination thereof.

The specified object (e.g., the first specified object and/or a second specified object) may be, for example, a fixed object relatively helpful for positioning for autonomous driving control of the driving device that travels in a specified space. The specified object meeting the specified condition may include at least one of, for example, a pillar, a table, a fire extinguisher, a sofa, or a combination thereof, which is included (or disposed) in a building.

In one example, the controller 130 may identify the first sampling rate to be applied to the first point cloud data corresponding to the first specified object.

As an example, the controller 130 may identify the first sampling rate required for sampling of the first point cloud data among the first sensing data. The controller 130 may identify the first sampling rate, using, for example, sampling rate information (e.g., a table) stored in the memory 120 and information of the identified first specified object.

In another example, the controller 130 may identify the second specified object included in the second sensing data.

The controller 130 may compare the first specified object included in the first sensing data with the second specified object included in the second sensing data. As an example, the controller 130 may determine whether the first specified object is substantially the same as the second specified object based on the compared result.

The controller 130 may identify a second sampling rate to be applied to second point cloud data corresponding to the second specified object based on the compared result.

As an example, when it is identified that the first specified object and the second specified object are the same as each other, the controller 130 may identify the second sampling rate as the same value as the first sampling rate or a value greater than the first sampling rate. In other words, when it is identified that the first specified object and the second specified object are the same as each other, the controller 130 may identify the second sampling rate as a value that is greater than or equal to the first sampling rate.

As another example, when the first specified object and the second specified object are not the same as each other or when the second specified object is not included in the second sensing data, the controller 130 may identify a predefined sampling rate (e.g., a sampling rate stored in the memory 120) as the second sampling rate. The controller 130 may sample the second sensing data including the second specified object using the predefined sampling rate. For example, the predefined sampling rate may be less than the first sampling rate.

The controller 130 may sample the first sensing data and the second sensing data respectively using the first sampling rate and the second sampling rate.

As an example, the controller 130 may sample the first point cloud data corresponding to the first specified object in the first sensing data, using the first sampling rate.

As another example, the controller 130 may sample the second point cloud data corresponding to the second specified object in the second sensing data, using the second sampling rate.

A sampling rate for point cloud data corresponding to a specified object among sensing data may be greater than a sampling rate corresponding to an area that does not correspond to the specified object (or an area where there is no specified object).

The controller 130 may generate voxel data using at least some of the sampling results.

As an example, the controller 130 may generate first voxel data including location information of at least one of the first specified object, the second specified object, or a combination thereof, based on at least one of the sampled first sensing data, the sampled second sensing data, or a combination thereof. The controller 130 may store at least a portion of map data including the first voxel data in the memory 120.

After obtaining the first sensing data and the second sensing data, the controller 130 may obtain third sensing data using the second sensor among the at least one sensor included in the sensor device 110 and may generate second voxel data using the third sensing data sampled based on the specified sampling rate. The second voxel data may include, for example, voxel coordinates of a blob corresponding to at least one object meeting the specified condition.

As an example, the controller 130 may identify the current location of the driving device, based on the result of matching the first voxel data included in the map data with the second voxel data. The controller 130 may apply, for example, various types of point cloud registration (e.g., iterative closest point (ICP)) algorithms to generate the result of matching the first voxel data with the second voxel data.

In one example, the controller 130 may set a weight for a portion that does not meet the specified condition between the first voxel data and the second voxel data to a first value and match the first voxel data with the second voxel data. For example, the first value may be “1”.

In another example, the controller 130 may set a weight for a portion meeting the specified condition, which includes at least one of the first specified object, the second specified object, or a combination thereof, to a second value greater than the first value and may match the first voxel data with the second voxel data. The second value may be a number greater than the first value (e.g., “1”).

The controller 130 may store various pieces of data generated by the above-mentioned operations in the memory 120.

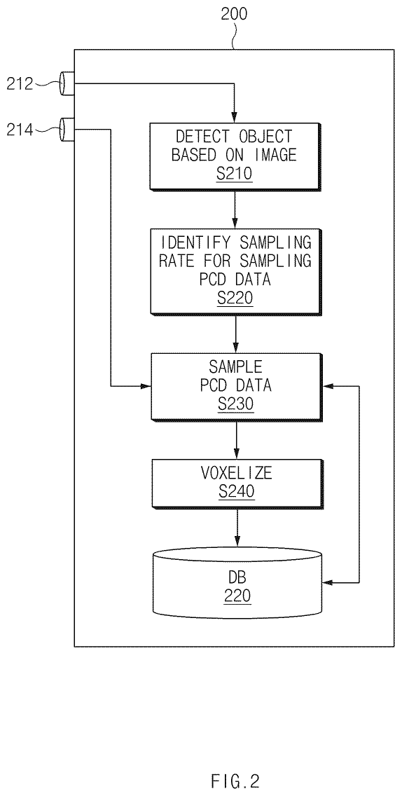

FIG. 2 is an operational conceptual diagram of an autonomous driving control apparatus according to an embodiment of the present disclosure.

According to an embodiment, an autonomous driving control apparatus 200 (e.g., the autonomous driving control apparatus 100 of FIG. 1) may generate voxel data based on sensing data obtained using at least one sensor 212 and 214 and may store the voxel data in a database (DB) 220 (e.g., the memory 120 of FIG. 1).

As an example, the autonomous driving control apparatus 200 may obtain first sensing data using the first sensor 212 (e.g., a red-green-blue (RGB) camera). The first sensing data may include data about a driving path of a driving device.

Referring to reference numeral S210, for example, the autonomous driving control apparatus 200 may detect an object based on an image included in the first sensing data. As an example, the autonomous driving control apparatus 200 may identify a first specified object that is included in the first sensing data and meets a specified condition. As an example, the autonomous driving control apparatus 200 may identify first point cloud data corresponding to the first specified object.

Referring to reference numeral S220, for example, the autonomous driving control apparatus 200 may identify a sampling rate for sampling point cloud data. As an example, the autonomous driving control apparatus 200 may identify a first sampling rate to be applied for sampling first point cloud data included in the first sensing data.

As another example, the autonomous driving control apparatus 200 may obtain second sensing data using the second sensor 214 (e.g., 3D LiDAR). The second sensing data may include data about a driving path of the driving device.

Referring to reference numeral S230, for example, the autonomous driving control apparatus 200 may sample point cloud data. As an example, the autonomous driving control apparatus 200 may sample at least a portion of the first sensing data including the first point cloud data.

The autonomous driving control apparatus 200 may set, for example, the first sampling rate for the first point cloud data corresponding to the first specified object to be greater than a sampling rate for sensing data corresponding to an area where there is no specified object to perform sampling. The autonomous driving control apparatus 200 may store at least a portion of the sampled first sensing data in the DB 220.

The autonomous driving control apparatus 200 may set, for example, a second sampling rate for second point cloud data corresponding to the second specified object to be greater than the sampling rate for the sensing data corresponding to the area where there is no specified object to perform sampling.

For example, the autonomous driving control apparatus 200 may determine the second sampling rate, based on the result of comparing the first specified object with the second specified object.

Referring to reference numeral S240, the autonomous driving control apparatus 200 may generate voxel data (i.e., voxelize) based on at least some of the sampled first sensing data and the sampled second sensing data. As an example, the autonomous driving control apparatus 200 may generate voxel data through a voxelization task for at least some of the sampled first sensing data and the sampled second sensing data. The autonomous driving control apparatus 200 may generate first voxel data including location information of at least one of the first specified object, the second specified object, or a combination thereof, based on at least one of the sampled first sensing data, the sampled second sensing data, or a combination thereof. The autonomous driving control apparatus 200 may store at least a portion of the sampled plural data in the DB 220.

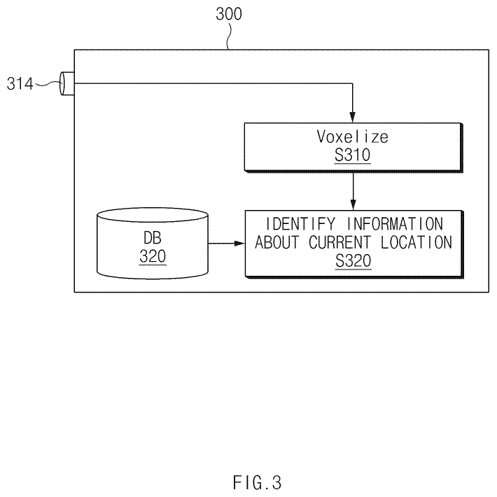

FIG. 3 is an operational conceptual diagram of an autonomous driving control apparatus according to an embodiment of the present disclosure.

According to an embodiment, an autonomous driving control apparatus 300 (e.g., the autonomous driving control apparatus 100 of FIG. 1 and/or the autonomous driving control apparatus 200 of FIG. 2) may generate voxel data based on sensing data obtained using at least one sensor and may store the voxel data in a DB 320 (e.g., the memory 120 of FIG. 1 and/or the DB 220 of FIG. 2).

For example, the autonomous driving control apparatus 300 may obtain third sensing data using a second sensor 314 (e.g., 3D LiDAR). The third sensing data may be sensing data obtained using the second sensor 314 after obtaining the second sensing data described above in the description of FIG. 2. For example, the third sensing data may include at least one piece of point cloud data.

Referring to reference numeral S310, for example, the autonomous driving control apparatus 300 may generate second voxel data based on the third sensing data. As an example, the autonomous driving control apparatus 300 may generate the second voxel data through a voxelization task (i.e., voxelize) for at least a portion of the third sensing data.

Referring to reference numeral S320, for example, the autonomous driving control apparatus 300 may identify information about a current location of a driving device. As an example, the autonomous driving control apparatus 300 may identify the information about the current location of the driving device based on the matching result generated by matching first voxel data with the second voxel data. As an example, the autonomous driving control apparatus 300 may match the first voxel data stored in the DB 320 with the generated second voxel data.

The autonomous driving control apparatus 300 may apply various types of point cloud registration (e.g., iterative closest point (ICP)) algorithms to generate the result of matching the first voxel data with the second voxel data.

In one example, the autonomous driving control apparatus 300 may set a weight for a portion that does not meet a specified condition between the first voxel data and the second voxel data to a first value and may match the first voxel data with the second voxel data. For example, the first value may be “1”.

In another example, the autonomous driving control apparatus 300 may set a weight for a portion meeting the specified condition including at least one of a first specified object, a second specified object, or a combination thereof to a second value greater than the first value and may match the first voxel data with the second voxel data. The second value may be, for example, a number greater than the first value (e.g., “1”).

Equation 1 below may be an equation used for the autonomous driving control apparatus 300 to modify a portion of the ICP algorithm using different weights and obtain information about the current location of the driving device.

$${T}_{opt} = \begin{matrix}arg min \\ T\end{matrix} {( {w}_{i} ( {T}_{{s}_{i}} - {d}_{i} ) {n}_{i} )}^{2} \qquad [ Equation 1 ]$$

For example, sᵢ may be the point cloud data and/or the voxel data currently obtained by the autonomous driving control apparatus 300. For example, dᵢ may be the point cloud data and/or the voxel data included in the map data. For example, nᵢ may be the normal vector in dᵢ. For example, wᵢ may be the weight. As an example, the autonomous driving control apparatus 300 may set the weight to a different value depending on whether it is associated with a specified object.

The autonomous driving control apparatus 300 may store

various pieces of data generated by the above-mentioned operations in the DB 320.

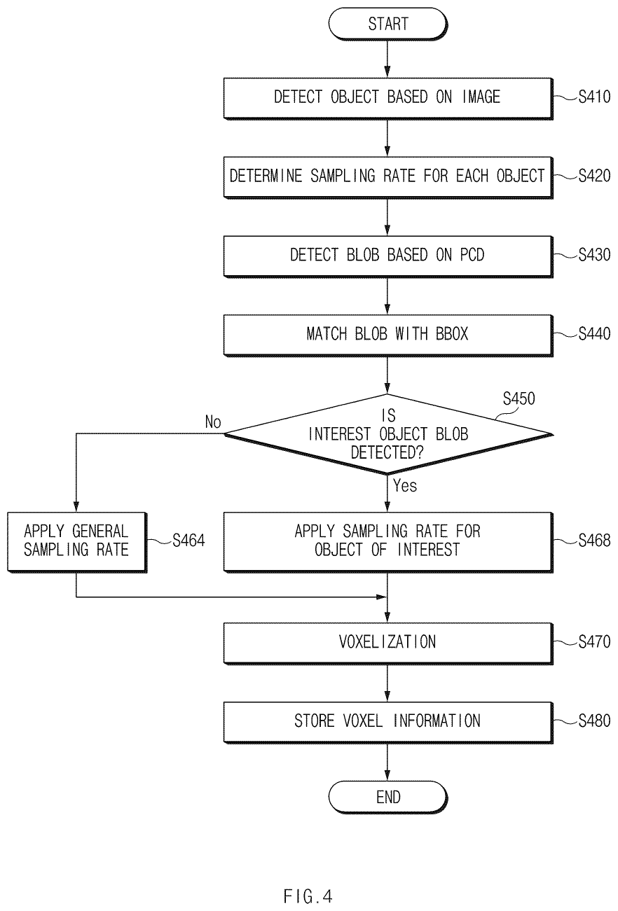

FIG. 4 is an operational flowchart of an autonomous driving control method according to an embodiment of the present disclosure.

According to an embodiment, an autonomous driving control apparatus (e.g., the autonomous driving control apparatus 100 of FIG. 1) may perform the operations disclosed in FIG. 4. For example, at least some of components (e.g., the sensor device 110 of FIG. 1, the memory 120 of FIG. 1, the controller 130 of FIG. 1, or a combination thereof) included in the autonomous driving control apparatus may be configured to perform the operations of FIG. 4.

Operations in S410 to S480 in an embodiment below may be sequentially performed, but are not necessarily sequentially performed. For example, an order of the respective operations may be changed, and at least two operations may be performed in parallel. Furthermore, contents that correspond to or are duplicative with the contents described above in conjunction with FIG. 4 may be briefly described or omitted.

According to an embodiment, in S410, the autonomous driving control apparatus may perform object detection based on an image.

For example, the autonomous driving control apparatus may detect an object, based on image data obtained using at least one camera included in the autonomous driving control apparatus. As an example, the autonomous driving control apparatus may identify a bounding box (Bbox) corresponding to the object.

According to an embodiment, in S420, the autonomous driving control apparatus may determine a sampling rate to be applied for sampling each object.

For example, when the object meets a specified condition, the autonomous driving control apparatus may perform sampling using a sampling rate of a relatively high value.

According to an embodiment, in S430, the autonomous driving control apparatus may detect a blob based on point cloud data among data obtained using at least one LiDAR included in the autonomous driving control apparatus.

According to an embodiment, in S440, the autonomous driving control apparatus may match the blob with the bounding box (Bbox).

For example, the autonomous driving control apparatus may determine whether the blob and the bounding box are identical to each other (or a degree of sameness between the blob and the bounding box).

According to an embodiment, in S450, the autonomous driving control apparatus may determine whether an interest object blob is detected.

For example, the autonomous driving control apparatus may compare a bounding box meeting the specified condition with at least one blob and may then detect a blob determined as being the same as the bounding box meeting the specified condition (or determined as an object of interest) as a result of the comparison.

In one example, when the interest object blob is detected (e.g., S450—Yes), the autonomous driving control apparatus may perform S468.

In another example, when the interest object blob is not detected (e.g., S450—No), the autonomous driving control apparatus may perform S464.

According to an embodiment, in S464, the autonomous driving control apparatus may apply a general sampling rate.

For example, when there is no interest object blob, the autonomous driving control apparatus may perform sampling using the general sampling rate for all the sensing data obtained using the LiDAR. The autonomous driving control apparatus may identify the general sampling rate using table data associated with a sampling rate stored in a memory included in the autonomous driving control apparatus.

According to an embodiment, in S468, the autonomous driving control apparatus may apply the sampling rate for the object of interest to data corresponding to the object of interest.

As an example, the autonomous driving control apparatus may identify a sampling rate for sampling the data (e.g., point cloud data) corresponding to the object of interest. As an example, the sampling rate for the object of interest may be greater than or equal to the general sampling rate in S464.

According to an embodiment, in S470, the autonomous driving control apparatus may perform voxelization for at least a portion of the sampled result.

According to an embodiment, in S480, the autonomous driving control apparatus may store at least a portion of the result of performing the voxelization in the memory.

For example, the autonomous driving control apparatus may store map data, including first voxel data generated as a result of performing the voxelization, in the memory.

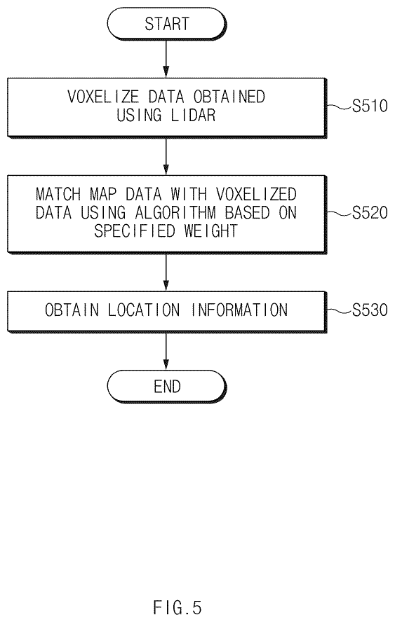

FIG. 5 is an operational flowchart of an autonomous driving control method according to an embodiment of the present disclosure.

According to an embodiment, an autonomous driving control apparatus (e.g., the autonomous driving control apparatus 100 of FIG. 1) may perform the operations disclosed in FIG. 5. For example, at least some of components (e.g., the sensor device 110 of FIG. 1, the memory 120 of FIG. 1, the controller 130 of FIG. 1, or a combination thereof) included in the autonomous driving control apparatus may be configured to perform the operations of FIG. 5.

Operations in S510 to S530 in an embodiment below may be sequentially performed, but are not necessarily sequentially performed. For example, an order of the respective operations may be changed, and at least two operations may be performed in parallel. Furthermore, contents that correspond to or are duplicative with the contents described above in conjunction with FIG. 5 may be briefly described or omitted. Furthermore, operations in S510 to S530 in an embodiment below may be operations performed after the above-mentioned operation in S480 of FIG. 4, but embodiments of the present disclosure are not limited thereto.

According to an embodiment, in S510, the autonomous driving control apparatus may voxelize data obtained using LiDAR included in the autonomous driving control apparatus.

For example, after storing the map data including the first voxel data in the memory in FIG. 4, the autonomous driving control apparatus may generate second voxel data based on sensing data obtained using the LiDAR.

According to an embodiment, in S520, the autonomous driving control apparatus may match the map data with the voxelized data (e.g., the second voxel data) using an algorithm based on a specified weight.

For example, the autonomous driving control apparatus may apply various types of point cloud registration (e.g., iterative closest point (ICP)) algorithms to generate the result of matching the first voxel data with the second voxel data.

As an example, the autonomous driving control apparatus may set a weight for a portion which does not meet a specified condition between the first voxel data and the second voxel data to a first value and may match the first voxel data with the second voxel data. For example, the first value may be “1”.

As an example, the autonomous driving control apparatus may set a weight for a portion meeting the specified condition, which includes at least one of a first specified object, a second specified object, or a combination thereof, to a second value greater than the first value and may match the first voxel data with the second voxel data. The second value may be, for example, a number greater than the first value (e.g., “1”).

According to an embodiment, in S530, the autonomous driving control apparatus may obtain information about a location of a driving device based on the matched result.

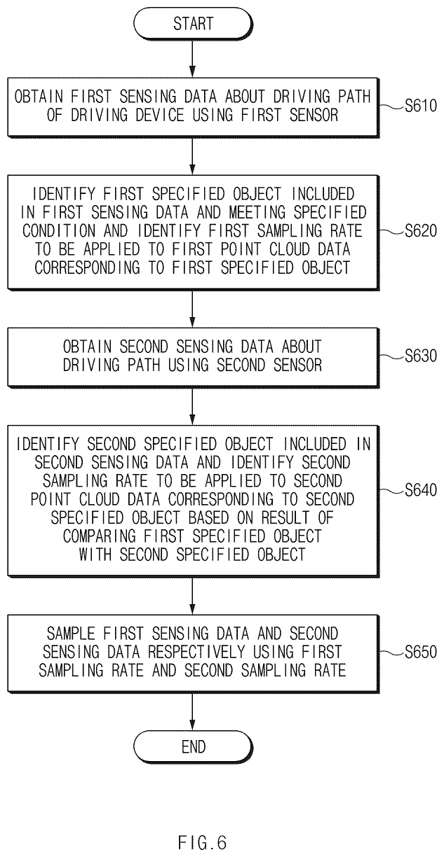

FIG. 6 is an operational flowchart of an autonomous driving control method according to an embodiment of the present disclosure.

According to an embodiment, an autonomous driving control apparatus (e.g., the autonomous driving control apparatus 100 of FIG. 1) may perform the operations disclosed in FIG. 6. For example, at least some of components (e.g., the sensor device 110 of FIG. 1, the memory 120 of FIG. 1, the controller 130 of FIG. 1, or a combination thereof) included in the autonomous driving control apparatus may be configured to perform the operations of FIG. 6.

Operations in S610 to S650 in an embodiment below may be sequentially performed, but are not necessarily sequentially performed. For example, an order of the respective operations may be changed, and at least two operations may be performed in parallel. Furthermore, contents that correspond to or are duplicative with the contents described above in conjunction with FIG. 6 may be briefly described or omitted.

According to an embodiment, in S610, the autonomous driving control apparatus may obtain first sensing data about a driving path of a driving device using a first sensor included in the autonomous driving control apparatus.

According to an embodiment, the autonomous driving control apparatus may identify a first specified object which is included in the first sensing data and meets a specified condition and may identify a first sampling rate to be applied to first point cloud data corresponding to the first specified object.

For example, the autonomous driving control apparatus may identify the first sampling rate using a table stored in a memory included in the autonomous driving control apparatus.

According to an embodiment, in S630, the autonomous driving control apparatus may obtain second sensing data about the driving path using a second sensor included in the autonomous driving control apparatus.

According to an embodiment, in S640, the autonomous driving control apparatus may identify a second specified object included in the second sensing data and may identify a second sampling rate to be applied to second point cloud data corresponding to the second specified object based on the result of comparing the first specified object with the second specified object.

In one example, when it is identified that the first specified object and the second specified object are the same as each other, the autonomous driving control apparatus may identify the second sampling rate as the same value as the first sampling rate or a value greater than the first sampling rate. In other words, when it is identified that the first specified object and the second specified object are the same as each other, the autonomous driving control apparatus may identify the second sampling rate as a value that is greater than or equal to the first sampling rate.

In another example, when the first specified object and the second specified object are not the same as each other or when the second specified object is not included in the second sensing data, the autonomous driving control apparatus may identify a predefined sampling rate (e.g., a sampling rate stored in the memory) as the second sampling rate. The autonomous driving control apparatus may sample the second sensing data including the second specified object using the predefined sampling rate. For example, the predefined sampling rate may be less than the first sampling rate.

According to an embodiment, in S650, the autonomous driving control apparatus may sample the first sensing data and the second sensing data respectively using the first sampling rate and the second sampling rate.

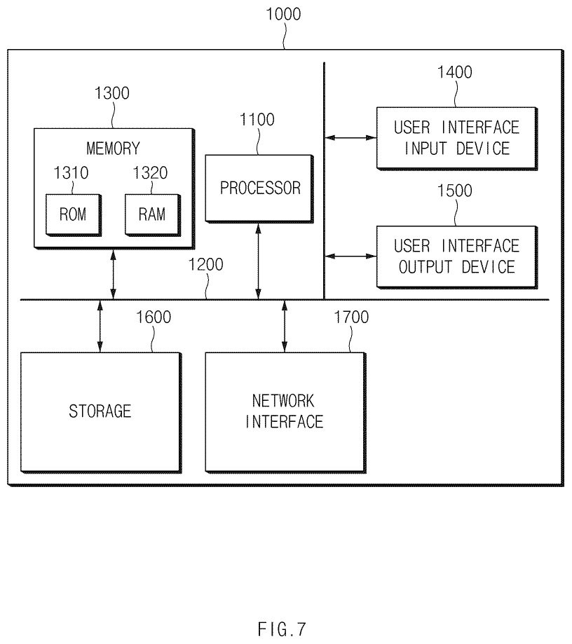

FIG. 7 illustrates a computing system of an autonomous driving control apparatus according to an embodiment of the present disclosure.

Referring to FIG. 7, a computing system 1000 of the autonomous driving control apparatus may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read-only memory (ROM) 1310 and a random-access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a RAM, a flash memory, a ROM, an erasable programmable ROM (EPROM), an electrically EPROM (EEPROM), a register, a hard disk, a removable disk, and a compact-disk ROM (CD-ROM).

The storage medium may be coupled to the processor 1100. The processor 1100 may read out information from the storage medium and may write information in the storage medium. Alternatively, the storage medium may be integrated with the processor 1100. The processor and the storage medium may reside in an application-specific integrated circuit (ASIC). The ASIC may reside within a user terminal. In another case, the processor and the storage medium may reside in the user terminal as separate components.

A description is given of effects of the autonomous driving control apparatus and the method thereof according to an embodiment of the present disclosure.

According to at least one of the embodiments of the present disclosure, the autonomous driving control apparatus may set a weight according to whether there is an object meeting a specified condition, in a process of processing data for autonomous driving of a driving device (or a mobile robot), and may generate map data using at least a portion of point cloud data, thus obtaining more efficient and accurate location information.

Furthermore, according to at least one of the embodiments of the present disclosure, the autonomous driving control apparatus may sample and store point cloud data among data obtained using the sensor based on a sampling rate of a specified numerical value, thus obtaining location information while reducing a storage capacity.

Furthermore, according to at least one of the embodiments of the present disclosure, the autonomous driving control apparatus may reduce sampling data for data (e.g., point cloud data) corresponding to an identified specified object, when identifying the specified object that provides relatively more information accurate when performing a positioning function about the driving device, thus preventing an accuracy degradation problem capable of occurring through sampling.

In addition, various effects ascertained directly or indirectly through the present disclosure may be provided.

Hereinabove, although the present disclosure has been described with reference to embodiments and the accompanying drawings, the present disclosure is not limited thereto. The present disclosure may be variously modified and altered by those having ordinary skill in the art to which the present disclosure pertains without departing from the spirit and scope of the present disclosure.

Therefore, embodiments of the present disclosure are not intended to limit the technical spirit of the present disclosure, and are provided only for illustrative purposes. The scope of the present disclosure should be construed based on the accompanying claims. All the technical ideas within the scope equivalent to the claims should be included in the scope of the present disclosure.

What is claimed is:

1. An autonomous driving control apparatus, comprising:
a sensor device including at least one sensor;
a memory storing at least one instruction; and
a controller electrically connected with the sensor device and the memory,
wherein the at least one instruction is configured to, when executed by the controller, cause the autonomous driving control apparatus to:
obtain first sensing data about a driving path of a driving device, using a first sensor among the at least one sensor;
identify a first specified object included in the first sensing data and meeting a specified condition, and identify a first sampling rate to be applied to a first point cloud data corresponding to the first specified object;
obtain second sensing data about the driving path, using a second sensor among the at least one sensor;
identify a second specified object included in the second sensing data and identify a second sampling rate to be applied to second point cloud data corresponding to the second specified object based on a result of comparing the first specified object with the second specified object; and
sample the first sensing data and the second sensing data respectively using the first sampling rate and the second sampling rate.

2. The autonomous driving control apparatus of claim 1, wherein the at least one instruction is configured to, when executed by the controller, cause the autonomous driving control apparatus to:
sample the first point cloud data corresponding to the first specified object in the first sensing data, using the first sampling rate; and
sample the second point cloud data corresponding to the second specified object in the second sensing data, using the second sampling rate.

3. The autonomous driving control apparatus of claim 1, wherein the at least one instruction is configured to, when executed by the controller, cause the autonomous driving control apparatus to:
identify the second sampling rate as the same value as the first sampling rate or a value greater than the first sampling rate, when it is identified that the first specified object and the second specified object are the same as each other.

4. The autonomous driving control apparatus of claim 1, wherein the at least one instruction is configured to, when executed by the controller, cause the autonomous driving control apparatus to:
sample at least a portion of the second sensing data using a predefined sampling rate, when the first specified object and the second specified object are not the same as each other or when the second specified object is not included in the second sensing data.

5. The autonomous driving control apparatus of claim 4, wherein the predefined sampling rate is less than the first sampling rate.

6. The autonomous driving control apparatus of claim 1, wherein the at least one instruction is configured to, when executed by the controller, cause the autonomous driving control apparatus to:
generate first voxel data including location information of at least one of the first specified object, the second specified object, or a combination thereof, based on at least one of the sampled first sensing data, the sampled second sensing data, or a combination thereof; and
store map data including the first voxel data in the memory.

7. The autonomous driving control apparatus of claim 6, wherein the at least one instruction is configured to, when executed by the controller, cause the autonomous driving control apparatus to:
generate second voxel data based on third sensing data obtained using the second sensor; and
identify a current location of the driving device, based on a result of matching the first voxel data included in the map data with the second voxel data.

8. The autonomous driving control apparatus of claim 7, wherein the at least one instruction is configured to, when executed by the controller, cause the autonomous driving control apparatus to:
set a weight for a portion that does not meet the specified condition between the first voxel data and the second voxel data to a first value and match the first voxel data with the second voxel data; and
set a weight for a portion meeting the specified condition, the portion including at least one of the first specified object, the second specified object, or a combination thereof, to a second value greater than the first value and match the first voxel data with the second voxel data.

9. The autonomous driving control apparatus of claim 7, wherein the second voxel data includes voxel coordinates of a blob corresponding to at least one object meeting the specified condition.

10. The autonomous driving control apparatus of claim 7, wherein the at least one instruction is configured to, when executed by the controller, cause the autonomous driving control apparatus to:
apply a point cloud registration algorithm to the first voxel data and the second voxel data to generate the result.

11. An autonomous driving control method, comprising:
obtaining, by a controller, first sensing data about a driving path of a driving device using a first sensor;
identifying, by the controller, a first specified object included in the first sensing data and meeting a specified condition, and identifying, by the controller, a first sampling rate to be applied to a first point cloud data corresponding to the first specified object;
obtaining, by the controller, second sensing data about the driving path using a second sensor;
identifying, by the controller, a second specified object included in the second sensing data and identifying, by the controller, a second sampling rate to be applied to second point cloud data corresponding to the second specified object based on a result of comparing the first specified object with the second specified object; and
sampling, by the controller, the first sensing data and the second sensing data respectively using the first sampling rate and the second sampling rate.

12. The autonomous driving control method of claim 11, wherein sampling the first sensing data and the second sensing data respectively using the first sampling rate and the second sampling rate by the controller includes:
sampling, by the controller, the first point cloud data corresponding to the first specified object in the first sensing data using the first sampling rate; and
sampling, by the controller, the second point cloud data corresponding to the second specified object in the second sensing data using the second sampling rate.

13. The autonomous driving control method of claim 11, wherein identifying the second sampling rate by the controller includes:
identifying, by the controller, the second sampling rate as the same value as the first sampling rate or a value greater than the first sampling rate when it is identified that the first specified object and the second specified object are the same as each other.

14. The autonomous driving control method of claim 11, wherein sampling the first sensing data and the second sensing data respectively using the first sampling rate and the second sampling rate by the controller includes:
sampling, by the controller, at least a portion of the second sensing data using a predefined sampling rate, when the first specified object and the second specified object are not the same as each other or when the second specified object is not included in the second sensing data.

15. The autonomous driving control method of claim 14, wherein the predefined sampling rate is less than the first sampling rate.

16. The autonomous driving control method of claim 11, further comprising:
generating, by the controller, first voxel data including location information of at least one of the first specified object, the second specified object, or a combination thereof, based on at least one of the sampled first sensing data, the sampled second sensing data, or a combination thereof; and
storing, by the controller, map data including the first voxel data in a memory.

17. The autonomous driving control method of claim 16, further comprising:
generating, by the controller, second voxel data based on third sensing data obtained using the second sensor; and
identifying, by the controller, a current location of the driving device, based on a result of matching the first voxel data included in the map data with the second voxel data.

18. The autonomous driving control method of claim 17, wherein identifying the current location of the driving device, based on the result of matching the first voxel data included in the map data with the second voxel data, by the controller includes:
setting, by the controller, a weight for a portion which does not meet the specified condition between the first voxel data and the second voxel data to a first value and matching, by the controller, the first voxel data with the second voxel data; and
setting a weight for a portion meeting the specified condition, the portion including at least one of the first specified object, the second specified object, or a combination thereof, to a second value greater than the first value and matching, by the controller, the first voxel data with the second voxel data.

19. The autonomous driving control method of claim 17, wherein the second voxel data includes voxel coordinates of a blob corresponding to at least one object meeting the specified condition.

20. The autonomous driving control method of claim 17, wherein identifying the current location of the driving device, based on the result of matching the first voxel data included in the map data with the second voxel data, by the controller includes:
applying, by the controller, a point cloud registration algorithm to the first voxel data and the second voxel data to generate the result.
